(19) United States
(12) Patent Application Publication
(10) Pub. No.: US 2026/0078289 A1
(43) Pub. Date: Mar. 19, 2026

(54) Diamond particles with multilayer hard coatings and polycrystalline diamond making therefrom

(71) Applicants: CNPC USA CORPORATION, Houston, TX (US); BEIJING HUAMEI, INC, Beijing (CN); CHINA NATIONAL PETROLEUM CORPORATION, Beijing (CN)

(72) Inventors: Jie CHEN, Katy, TX (US); Kai ZHANG, Katy, TX (US); Chris CHENG, Katy, TX (US); Peng QI, Beijing (CN); Xiao FENG, Beijing (CN)

(21) Appl. No.: 18/885,594

(22) Filed: Sep. 14, 2024

(51) Int. Cl. C09K 3/14

(52) U.S. Cl. CPC C09K 3/1436

(57) ABSTRACT

A superabrasive compact and a method of making the superabrasive compact are disclosed. A superabrasive compact may comprise a diamond body and a metallic substrate. The diamond body comprises diamond particles. Diamond particles may have a plurality of layers of inorganic hard coatings on surface of diamond particles. The plurality of layers of coatings may have thickness ranging from about 0.1% to about 20% of the size of the diamond particle. The metallic substrate may be in direct contact with the diamond body.

### TECHNICAL FIELD AND INDUSTRIAL APPLICABILITY

The present invention relates generally to superabrasive materials and a method of making superabrasive compact, and more particularly, to diamond particles consisting of multilayer hard coatings to manufacture a polycrystalline diamond compact (PDC) cutter (or “cutting element”) for drill bits.

### BACKGROUND OF THE INVENTION

Polycrystalline diamond materials and PDC cutters formed therefrom are well known in the art. Conventionally, polycrystalline diamond is usually formed by combining diamond grains with a suitable binder/catalyst material under a high-pressure high-temperature (HPHT) condition. The mixture is subjected to conditions of extremely high temperature/high pressure, where the binder/catalyst material promotes desired intercrystalline diamond-to-diamond bonding between the grains, thereby forming a polycrystalline diamond structure. The resulting polycrystalline diamond structure produces enhanced properties of hardness and wear resistance, making polycrystalline diamond materials extremely useful in aggressive wear and cutting applications where high levels of hardness and wear resistance are desired. Binder/catalyst materials that are typically used for forming polycrystalline diamond include Group VIII elements, cobalt (Co) being the most common. Conventional polycrystalline diamond can comprise from 85 to 95% by volume diamond and a remaining amount of the binder/catalyst material. The binder/catalyst material is present in the polycrystalline diamond material within interstices that exist between the bonded together diamond grains.

PDC cutters typically have a polycrystalline diamond table (or “diamond table” for short) supported by a cermet (e.g., cemented tungsten carbide-cobalt, or WC—Co) substrate and have long been used in earth-boring tools, especially in the oil & gas drilling fields.

The cermet substrate materials have a much larger coefficient of thermal expansion (CTE) than that of the polycrystalline diamond table. Due to the large difference in CTE and large change in temperature during the HPHT process, a high residual thermal stress may be generated in the PDC cutter even with procedures trying to alleviate it. Post-processes after HPHT and following field applications also cause a temperature change that would pose additional thermal stress to the PDC cutter. The residue stress in PDC cutters will be superimposed with externally applied loads and when the overall stress level near the cutting face reaches a certain threshold, the PDC will spall and/or chip, causing an accelerated wear. The situation gets worse when drilling in non-uniform formations and/or in the case of bit whirl where severe impact load occurs, and spall, chipping and sometimes, gross fracture are the main failure modes of PDC cutters.

The intrinsic brittleness of the polycrystalline diamond material plus the residue stress makes PDC cutters vulnerable to impact loads.

It is, therefore, desired that a polycrystalline diamond material be developed that has higher toughness when compared to conventional polycrystalline diamond, so that PDC cutters being made of it have higher impact resistance.

### SUMMARY

In one embodiment, a superabrasive compact may comprise a diamond body and a metallic substrate. The diamond body comprises diamond particles. Diamond particles may have a plurality of layers of inorganic hard coatings on surface of diamond particles. The plurality of layers of coatings may have thickness ranging from about 0.1% to about 20% of the size of the diamond particle. The metallic substrate may be in direct contact with the diamond body.

Optionally in any embodiment, the inorganic hard coatings are at least one of coatings of diamond, diamond-like carbon (DLC), lonsdaleite, metal carbides including boron carbide, tungsten carbide, silicon carbide, tantalum carbide, niobium carbide, molybdenum carbide, titanium carbide, vanadium carbide, zirconium carbide, hafnium carbide, metal nitrides including cubic boron nitride (CBN), silicon nitride, tantalum nitride, niobium nitride, titanium nitride, vanadium nitride, zirconium nitride, hafnium nitride, aluminum nitride, carbon nitride, metal oxides including zirconium oxide, aluminum oxide, and mixtures of thereof.

Optionally in any embodiment, the inorganic hard coatings have surface coatings on some or all of the inorganic hard coatings.

Optionally in any embodiment, the metallic substrate comprises a metal carbide.

Optionally in any embodiment, the inorganic hard coatings have Knoop hardness value of greater than or equal to about 1,300 Kgf/mm².

Optionally in any embodiment, the diamond body has a first volume of the diamonds and a second volume of the diamonds.

Optionally in any embodiment, the first volume of the diamonds particles have the plurality of layers of inorganic hard coatings on surface of diamond particles; a second volume of the diamonds particles have no layers of inorganic hard coatings.

Optionally in any embodiment, the first volume of the diamonds and the second volume of the diamonds form multilayers with boundaries.

Optionally in any embodiment, the first volume of the diamonds and the second volume of the diamonds form a concentric ring.

Optionally in any embodiment, the first volume of the diamonds and the second volume of the diamonds form slices with boundaries.

Optionally in any embodiment, the cermet substrate is cemented WC-Co.

Optionally in any embodiment, the surface coating is at least one of coatings of pyrolytic carbon, amorphous carbon, glassy carbon, graphite, graphene, carbon nanotubes, hexagonal boron nitride, tungsten, molybdenum, tantalum, niobium, vanadium, zirconium, hafnium, chromium, rhenium, and mixtures of thereof.

In another embodiment, a superabrasive compact may comprise a first volume of diamond particles having a plurality of layers of inorganic hard coatings on surface of diamond particles. The plurality of layers of coatings have thickness ranging from about 0.1% to about 20% of the size of the diamond particle. The plurality of layers of coatings are at least one of coatings of diamond, diamond-like carbon (DLC), lonsdaleite, metal carbides including boron carbide, tungsten carbide, silicon carbide, tantalum carbide, niobium carbide, molybdenum carbide, titanium carbide, vanadium carbide, zirconium carbide, hafnium carbide, metal nitrides including cubic boron nitride (CBN), silicon nitride, tantalum nitride, niobium nitride, titanium nitride, vanadium nitride, zirconium nitride, hafnium nitride, aluminum nitride, carbon nitride, metal oxides including zirconium oxide, aluminum oxide, and mixtures of thereof.

Optionally in any embodiment, the diamond body further comprises a second volume of diamond having no plurality of layers of inorganic hard coatings.

Optionally in any embodiment, the inorganic hard coatings have surface coatings on some or all of the inorganic hard coatings.

Optionally in any embodiment, the inorganic hard coatings have Knoop hardness value of greater than or equal to about 1,300 Kgf/mm².

Optionally in any embodiment, the first volume of the diamonds and the second volume of the diamonds form multilayers structure.

Optionally in any embodiment, the first volume of the diamonds and the second volume of the diamonds form a concentric ring.

Optionally in any embodiment, the first volume of the diamonds and the second volume of the diamonds form slices with boundaries.

Optionally in any embodiment, the superabrasive compact may be further attached to a cermet substrate to form a conventional PDC cutter.

In yet another embodiment, a method of manufacturing a superabrasive compact may comprise steps of pre-processing diamond particles; coating diamond particles with various materials; assembling the coated diamond particles in a metal can; and sintering the diamond composite blend under high temperature and high pressure.

Optionally in any embodiment, the method may comprise the step of surface coating on the coated diamond particles.

Optionally in any embodiment, the assembling the coated diamond particles comprises assembling a first volume of diamonds containing a coated diamond particles as a first volume and non-coated diamond particles as a second volume of diamonds.

Optionally in any embodiment, the assembling may comprise the step of disposing the diamond composite blend on a cermet substrate and together sealed in a metal can, and a superabrasive compact containing binder/catalyst and a substrate is fabricated under normal HPHT.

### BRIEF DESCRIPTION OF THE DRAWINGS

The foregoing summary, as well as the following detailed description of the embodiments, will be better understood when read in conjunction with the appended drawings. It should be understood that the embodiments depicted are not limited to the precise arrangements and instrumentalities shown.

FIG. 1(a) is a schematic perspective view of a cylindrical shape polycrystalline diamond compact produced in a high pressure high temperature (HPHT) process according to an embodiment;

FIG. 1(b) is a schematic perspective view of a cylindrical shape polycrystalline diamond compact produced in a high pressure high temperature (HPHT) process according to another embodiment;

FIG. 2 shows an isometric cross-sectional illustration of embodiment of a coated diamond particle according to one exemplary embodiment.

FIG. 3 shows an isometric cross-sectional illustration of embodiment of a coated diamond particle according to another exemplary embodiment.

FIG. 4 shows an embodiment of a process manufacturing a superabrasive compact containing a PCD composite.

FIG. 5(a) shows a cross-sectional view of an embodiment of assembly to fabricate a superabrasive compact according to one exemplary embodiment.

FIG. 5(b) shows a prospective view of an embodiment of assembly to fabricate a superabrasive compact according to one exemplary embodiment.

### DETAILED DESCRIPTION

Before the description of the embodiment, terminology, methodology, systems, and materials are described; it is to be understood that this disclosure is not limited to the particular terminologies, methodologies, systems, and materials described, as these may vary. It is also to be understood that the terminology used in the description is for the purpose of describing the particular versions of embodiments only, and is not intended to limit the scope of embodiments. For example, as used herein, the singular forms “a,” “an,” and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art.

Unless otherwise indicated, all numbers expressing quantities of ingredients, properties such as size, weight, reaction conditions and so forth used in the specification and claims are to the understood as being modified in all instances by the term “about”. Accordingly, unless indicated to the contrary, the numerical parameters set forth in the following specification and attached claims are approximations that may vary depending upon the desired properties sought to be obtained by the invention. At the very least, and not as an attempt to limit the application of the doctrine of equivalents to the scope of the claims, each numerical parameter should at least be construed in light of the number of reported significant digits and by applying ordinary rounding techniques.

Cutting tables and cutting elements for use in earth-boring tools are described, as are earth-boring tools including the cutting elements, and methods of forming and using the cutting tables, the cutting elements, and the earth-boring tools. The configurations of the cutting tables, cutting elements, and earth-boring tools described herein may provide enhanced drilling efficiency and improved operational life as compared to the configurations of conventional cutting tables, conventional cutting elements, and conventional earth-boring tools.

The following description provides specific details, such as specific shapes, specific sizes, specific material compositions, and specific processing conditions, in order to provide a thorough description of embodiments of the present disclosure. However, a person of ordinary skill in the art would understand that the embodiments of the disclosure may be practiced without necessarily employing these specific details. Embodiments of the disclosure may be practiced in conjunction with conventional fabrication techniques employed in the industry. In addition, the description provided below does not form a complete process flow for manufacturing a cutting table, a cutting element, or an earth-boring tool. Only those process acts and structures necessary to understand the embodiments of the disclosure are described in detail below. Additional acts to form a complete cutting table, a complete cutting element, or a complete earth-boring tool from the structures described herein may be performed by conventional fabrication processes.

Drawings presented herein are for illustrative purposes only, and are not meant to be actual views of any particular material, component, structure, device, or system. Variations from the shapes depicted in the drawings as a result, for example, of manufacturing techniques and/or tolerances, are to be expected. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

As used herein, the terms “comprising,” “including,” “containing,” and grammatical equivalents thereof are inclusive or open-ended terms that do not exclude additional, unrecited elements or method steps, but also include the more restrictive terms “consisting of” and “consisting essentially of” and grammatical equivalents thereof. As used herein, the term “may” with respect to a material, structure, feature, or method act indicates that such is contemplated for use in implementation of an embodiment of the disclosure and such term is used in preference to the more restrictive term “is” so as to avoid any implication that other, compatible materials, structures, features, and methods usable in combination therewith should or must be excluded.

As used herein, the term “about” in reference to a given parameter is inclusive of the stated value and has the meaning dictated by the context (e.g., it includes the degree of error associated with measurement of the given parameter).

As used herein, the terms “earth-boring tool” and “earth-boring drill bit” mean and include any type of bit or tool used for drilling during the formation or enlargement of a wellbore in a subterranean formation and include, for example, fixed-cutter bits, roller cone bits, percussion bits, core bits, eccentric bits, bicenter bits, reamers, mills, drag bits, hybrid bits (e.g., rolling components in combination with fixed cutting elements), and other drilling bits and tools known in the art.

As used herein, the term “superabrasive compact” means and includes any structure comprising a polycrystalline material formed by a process that involves application of pressure (e.g., compaction) to the precursor material or materials used to form the polycrystalline material. The term “superabrasive compact”, as used herein, also refers to a sintered product made using super abrasive particles, such as diamond feed or cubic boron nitride particles. The compact may include a support, such as a cermet support, or may not include a support. The “superabrasive compact” is a broad term, which may include cutting element, cutters, or polycrystalline cubic boron nitride insert.

In turn, as used herein, the term “polycrystalline material” means and includes any material comprising a plurality of grains or crystals of the material that are bonded directly together by inter-granular bonds. The crystal structures of the individual grains of the material may be randomly oriented in space within the polycrystalline material.

As used herein, the term “material for inorganic hard coatings” means and includes any material having a Knoop hardness value of greater than or equal to about 1,300 Kgf/mm² (29,420 MPa). Non-limiting examples of materials include diamond (e.g., natural diamond, synthetic diamond), diamond-like carbon (DLC), lonsdaleite, metal carbides including boron carbide, tungsten carbide, silicon carbide, tantalum carbide, niobium carbide, molybdenum carbide, titanium carbide, vanadium carbide, zirconium carbide, hafnium carbide, metal nitrides including cubic boron nitride (CBN), silicon nitride, tantalum nitride, niobium nitride, titanium nitride, vanadium nitride, zirconium nitride, hafnium nitride, aluminum nitride, carbon nitride, metal oxides including zirconium oxide, aluminum oxide, and mixtures of thereof.

As used herein, the term “about” means plus or minus 10% of the numerical value of the number with which it is being used. Therefore, about 50% means in the range of 45%-55%.

As used herein, the term “superabrasive particles” may refer to ultra-hard particles or superabrasive particles having a Knoop hardness of 3500 KHN or greater. The superabrasive particles may include diamond and cubic boron nitride, for example.

The term “abrasive”, as used herein, refers to any material used to wear away softer materials.

The term “particle” or “particles”, as used herein, refers to a discrete body or bodies. A particle is also considered a crystal or a grain.

The term “polycrystalline diamond” or “PCD”, as used herein, refers to a plurality of randomly oriented or highly oriented monocrystalline diamond particles, which may represent a body or a particle consisting of a large number of smaller monocrystalline diamond particles of any sizes. Polycrystalline diamond particles usually do not have cleavage planes. In one particular case, a polycrystalline diamond comprises crystalline diamond grains, bound to each other by strong diamond-to-diamond bonds and form a rigid polycrystalline diamond body, and the inter-grain regions, disposed between the bounded grains and filled in one part with a binder/catalyst material (so called “binder/catalyst-containing”), which was used to promote diamond bonding during fabrication, and other part may be filled with other materials which may remain after the sintering of diamond table. Suitable metal solvent catalysts may include the iron group transitional metal in Group VIII of the periodic table. In another case, a polycrystalline diamond comprises only crystalline diamond grains, bound to each other by strong diamond-to-diamond bonds and form a rigid polycrystalline diamond body, without any catalyst or binder material between diamond grains, so called “binder/catalyst-free”.

The terms “diamond particle” or “particles” or “diamond powder”, which is a plurality of a large number of single crystal or polycrystalline diamond particles, are used synonymously in the instant application and have the same meaning as “particle” defined above.

The term “diamond-like-carbon (DLC)” refers to amorphous carbon materials with carbon atoms bonded in mainly sp³ and sp² hybridizations. DLC described in this invention contains significant fractions (20% or higher) of sp³ type carbon bonds, which can be hydrogenated or non-hydrogenated.

The term “polycrystalline diamond compact” or “PDC”, refers to the cutter or cutting element of a PDC drill bit, and it typically consists of a polycrystalline diamond table and a cermet substrate bonded together.

PCD materials of this invention are specially engineered to provide higher toughness, and more impact resistance when compared to conventional PCD materials and PDC cutters formed therefrom are, therefore, referred to as impact resistance enhancement PDC cutters.

Approaches to improve the impact resistance of PDC cutters may include 1) reducing the residual stress in PDC so that the overall stress level is reduced when the cutter encounters an impact, 2) reducing the peak impact force by using a non-planar/shaped/3D cutting face, 3) increasing the toughness of PCD by introducing mechanisms to deflect, bridge or stop the propagating crack.

To reduce the internal residual stress and improve the interface bonding, substrates with a variety of non-planar/patterned interfacial surfaces have been proposed. In addition to tuning the substrate interfacial surface structure, transitional or compositional gradient layers near the PCD and cermet substrate interface have also been introduced in some designs. The similarity of these approaches is to replace the abrupt change of CTE from the substrate to the diamond table with a gradual change, and/or increase the total diamond table/substrate interface area.

To reduce the external impact stress, various non-planar/shaped/3D cutting surface have been proposed. Changing the track of a propagating crack can alleviate the impact of a crack.

The approaches mentioned above are examples to reduce total stress level in the PCD layer or change the propagation track of a crack, while generally not changing the toughness of the PCD itself. PCD made by normal HPHT typically shows slightly higher fracture toughness with larger main diamond grain size, and turning diamond grains size has been used in industry to improve the PDC impact resistance. Yet this approach can only improve the toughness to some degree.

This current invention discloses embodiments of a PDC structure with a diamond table that includes diamond particles with multilayer hard coatings. The diamond particles with multilayer hard coatings are specifically engineered to improve the toughness and impact resistance of conventional PCD. This new PDC structure containing diamond grains with multilayer hard coatings, has the potential to deflect the crack path and absorb more energy during crack propagation and improve the overall impact resistance of PDC. More specifically, the multilayer hard coatings may deflect and/or stop a propagating crack, and absorb more energy. The stress field in multilayer hard coating structure may deflect, change the mode, and/or arrest a propagating crack; Superhard compact incorporating diamond particles with multilayer hard coating may have increased impact resistance. Superhard compact incorporating diamond particles with multilayer hard coating may have increased thermal resistance.

This current invention discloses embodiments of a PDC structure with a diamond table that includes diamond particles having a plurality of layers of inorganic hard coatings on surface of diamond particles, forming a PCD composite or diamond composite. This new PDC structure containing a PCD composite has the potential to absorb more energy during crack propagation and improve its overall impact resistance.

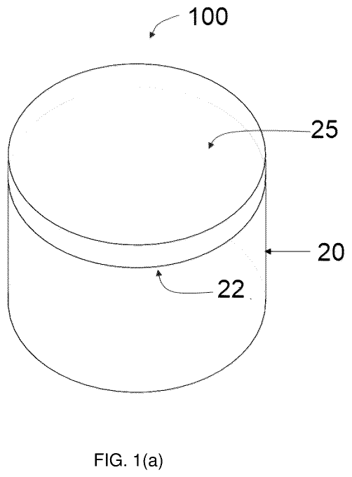

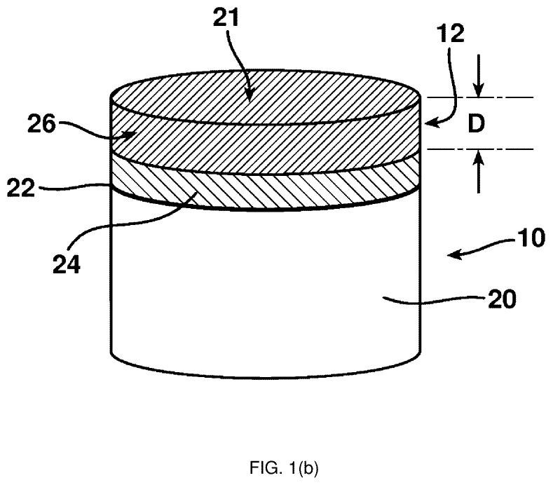

A superabrasive compact 100 in accordance with an embodiment is shown in FIG. 1(a). Superabrasive compact 100 may be inserted into a downhole of a suitable tool, such as a drill bit, for example. One example of the superabrasive compact 100 may include a diamond body 25.

In one embodiment, the superabrasive compact 100 may be a standalone compact without a substrate. In another embodiment, the superabrasive compact 100 may include a metallic substrate 20 in direct contact with the diamond body 25 formed by a plurality of polycrystalline diamond particles.

The metallic substrate 20 may be cemented metal carbide, attached to the diamond body 25 via an interface 22 separating the diamond body 25 and the substrate 20. The interface 22 may have an uneven interface. Substrate 20 may be made from hard metal carbides and a binder having carbon at least partially dissolved therein. In one embodiment, the substrate 20 may be cemented cobalt tungsten carbide, while the diamond body 25 may comprise diamond particles having a plurality of layers of inorganic hard coatings on surface of diamond particles.

Still in FIG. 1(b), the diamond body 21 may include at least two layers with a first layer 26 and a second layer 24. The second layer 24 may be closer to interface 22 and may be sandwiched between the substrate 20 and the first layer 26.

The superabrasive compact 10 may be referred to as a polycrystalline diamond compact (“PCD”) when polycrystalline diamond is used to form the diamond body 12. PCD compacts are known for their toughness and durability, which allow them to be an effective cutter in demanding applications. Although one type of superabrasive compact 10 has been described, other types of superabrasive compacts 10 may be utilized. For example, in one embodiment, superabrasive compact 10 may have a chamfer (not shown) around an outer peripheral of the top surface 21. The chamfer may have a vertical height of about 0.5 mm or 1 mm, for example, and an angle of about 45° degrees, for example, which may provide a particularly strong and fracture resistant tool component. The superabrasive compact 10 may be a subject of procedure depleting catalyst metal (e.g. cobalt) near the cutting surface of the compact, for example, by chemical leaching of cobalt in acidic solutions. The unleached superabrasive compact may be fabricated according to processes known to persons having ordinary skill in the art.

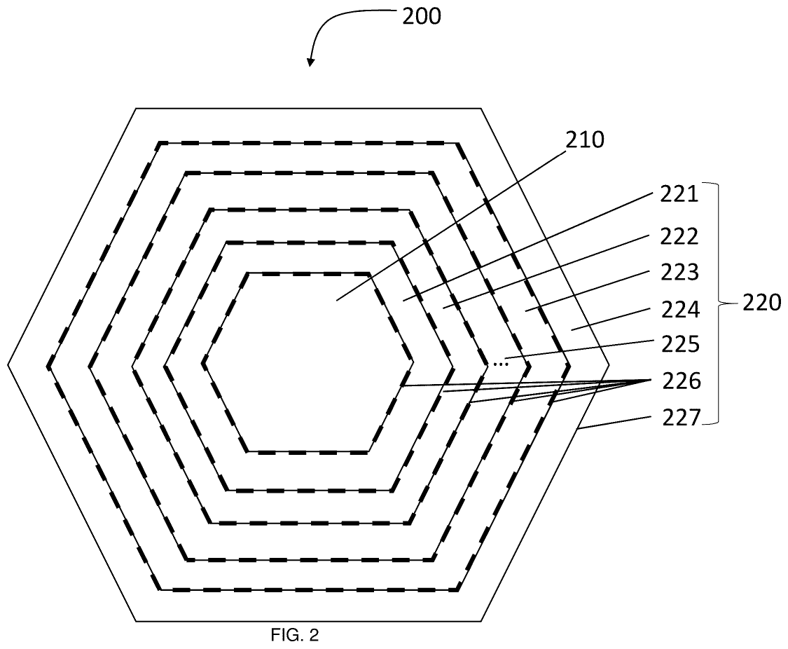

As shown in FIG. 2, a coated diamond particle 200 comprises a diamond particle 210 and a coating scheme 220. The coating scheme 220 is on the surface of the diamond particle 210.

The specific coating scheme 220 has a multilayer structure which contains one or more inorganic hard coating layers that contain at least one of coatings of diamond, diamond-like carbon (DLC), lonsdaleite, metal carbides including boron carbide, tungsten carbide, silicon carbide, tantalum carbide, niobium carbide, molybdenum carbide, titanium carbide, vanadium carbide, zirconium carbide, hafnium carbide, metal nitrides including cubic boron nitride (CBN), silicon nitride, tantalum nitride, niobium nitride, titanium nitride, vanadium nitride, zirconium nitride, hafnium nitride, aluminum nitride, carbon nitride, metal oxides including zirconium oxide, aluminum oxide, and mixtures of thereof, which have Knoop hardness value of greater than or equal to about 1,300 Kgf/mm², and one or more surface coating that contain pyrolytic carbon, amorphous carbon, glassy carbon, graphite, graphene, carbon nanotubes, hexagonal boron nitride, tungsten, molybdenum, tantalum, niobium, vanadium, zirconium, hafnium, chromium, rhenium, and mixtures of thereof, which has a lower hardness. Using these two coating layers, i.e., higher hardness layer and lower hardness layer, in a particular arrangement (or architecture) results in an increase (or maximization) of the toughness and impact resistance from the diamond cutters interface down to the substrate and the coating-cutter interface.

More specifically, the multilayer hard coating structure has multiple interfaces with change in grain size, and/or crystal orientation, and/or composition, and/or stress level, that can deflect and/or stop a propagating crack, and absorb more energy, functioning like the well-known multilayer interphases in fiber composites. The multilayer hard coating structure in this invention has the potential to reduce the damage of a propagating crack under impact load and improve the impact resistance of cutters including such a structure.

The diamond grains, together with the hard coating layers have less capability to dissipate the peak impact force due to their high hardness. To overcome the presence of excessive peak impact, a coating scheme 220 can have an underlying surface coating layer 226 of pyrolytic carbon, amorphous carbon, glassy carbon, graphite, graphene, carbon nanotubes, hexagonal boron nitride, tungsten, molybdenum, tantalum, niobium, vanadium, zirconium, hafnium, chromium, rhenium, and mixtures of thereof. The underlying surface coating layer serves to dissipate the peak impact load in the top coating layer 224 so that peak impact will spread in all directions (e.g., in a direction perpendicular, as well as parallel to the surface) within the inorganic hard coating layer. Such peak impact dissipation (or spatial distribution of peak impact) removes the excessive concentration of peak impact at the cutting edge.

As the peak impact transfer proceeds sequentially from the top coating layer 224 to the innermost coating layer 221, the coating layers in the multilayer coating sequence (or coating architecture) dissipate or spread-away the impact energy. The result of the coating functioning to alternatively deflect and stop a propagating crack before it reaches the diamond grain 210. Further, the presence of another surface coating layer, which has a lower hardness functioning as a cushion, between the diamond grain and the base layers help to protect the diamond grains from the impact load. The delay or reduction of peak impact cracking in the diamond grains typically increases the useful life of the diamond cutting cutters.

FIG. 2 illustrates in a cross-sectional form a specific embodiment of the peak impact-resistant coating scheme generally designated as coating scheme 220 of the invention. Chemical vapor infiltration (CVI), chemical vapor deposition (CVD), plasma-enhanced CVD like microwave plasma CVD, metal-organic chemical vapor deposition (MOCVD), atomic layer deposition (ALD), molecular beam epitaxy (MBE), physical vapor deposition (PVD) is the technique used to apply coating scheme 220. The impact-resistant coating scheme 220 comprises an underlayer 221, which contains inorganic hard coating. The coating scheme 220 further contains a top layer 224, which contains inorganic hard coating. The underlayer 221 and the top layer 224 each exhibit the same or lower hardness than the diamond 210 as discussed above. The coating scheme 220 also contains a mediate multi-periodicity layer coating scheme (see bracket 220), which contains inorganic hard coating. The impact-resistant coating scheme 220 has about 2 to 50 layers, for example. Each coating thickness is equal to between about 2 nanometers and about 1,000 nanometers. The total thickness may be about 0.1% to about 20% of the size of the diamond core. The different coating layers in the mediate multi-periodicity layer coating scheme can be of different compositions that have different peak impact coefficient. By selectively arranging the coating layers in the mediate multi-periodicity layer coating scheme one achieves a coating architecture that functions to alternatively block peak impact transfer or dissipate impact, which results in a reduction of impact in the diamond core and at the coating-diamond interface.

The coating scheme also includes a lower hardness surface coating layer 226 that is on top of the underlayer 221 and diamond core 210. The lower hardness surface coating layer 226 provides a transition between the underlayer 221 to the mediate multi-periodicity layer coating scheme 220. There is a surface coating layer 226 that provides a transition between the mediate multi-periodicity layer coating scheme 220 and the top layer 224.

In this specific embodiment, the underlayer 221 is closest to the diamond 210 and the top layer 224 is farthest from the substrate. The mediate multi-periodicity layer coating scheme 220 is mediate of the lower transition coating layer 221 and the upper transition coating layer 224. The diameter of the diamond core can be 0.2 μm to 50 μm, preferably 3 μm to 30 μm, for example. The inorganic hard layers can be continuous or discrete, i.e., the layer can be composed of isolated particles or small non-connected coating sections. The inorganic hard layers can be the same material, or a few different materials. For example, the inorganic hard coatings can be only diamond layers, or diamond and cubic boron nitride layers, or any combination of the hard layers mentioned above. The grain size of each inorganic hard layer can be the same or different, on the nanometer or micrometer scale. For example, one layer may have grain size on the nanometer scale, and another layer may have grain size on the micrometer scale. The thickness of each hard layer can be the same or different. The multilayer hard coatings may have a similar structure like a distributed Bragg reflector or a super lattice. The interface coatings or surface coating 226 can be the same material, such as pyrolytic carbon, or pyrolytic carbon and metal, or any combination of the interface and surface coating materials mentioned above. The interface coatings may be present under all hard coatings, or present only under a few of the hard coatings. In another embodiment, the present invention embodiment does not have any surface coating 226.

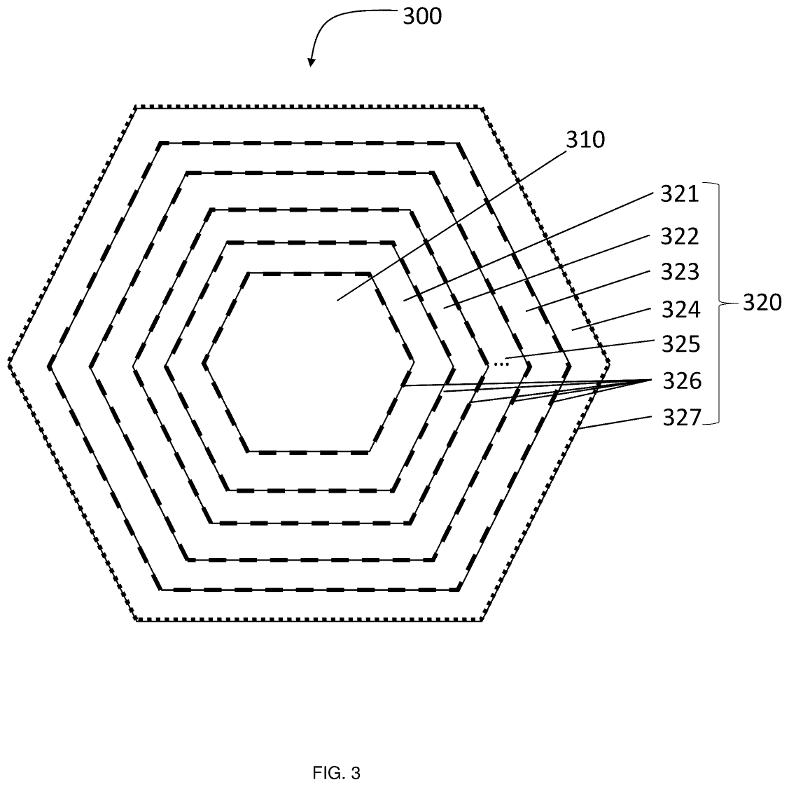

There should be an appreciation that other underlayers (or multiple coating layers) could be located between the underlayer 221 and the surface of the diamond 210 other than surface coating 226 on the diamond surface. There should also be an appreciation that a top surface coating layer 327 (or top coating layer on scheme of multiple coating layers) could be on the top surface 227 of the top layer 224, as shown in FIG. 3.

The surface coatings can be the same material, such as pyrolytic carbon, or pyrolytic carbon and metal, or any combination of the interface and surface coating materials mentioned above. The thickness of each interface or surface coating can be the same or different. The interface coatings may be present under all hard coatings, or present only under a few of the hard coatings.

In reference to the mediate multi-periodicity layer coating scheme 220 or 320, it comprises a plurality of sets of alternating layer arrangements (see 326, 321, 326, 322, 326, 323, 326, and 324). There should be an appreciation that the number of alternating layer arrangements like that of 320 can vary depending upon the specific application for the diamond cutters or polycrystalline diamond compact. Referring to alternating layer arrangement 320, which is representative of the other alternating layer arrangements, arrangement 320 contains an inorganic hard layer 321, 322, 323, 324, which comprises diamond, diamond-like carbon (DLC), lonsdaleite, metal carbides including boron carbide, tungsten carbide, silicon carbide, tantalum carbide, niobium carbide, molybdenum carbide, titanium carbide, vanadium carbide, zirconium carbide, hafnium carbide, metal nitrides including cubic boron nitride (CBN), silicon nitride, tantalum nitride, niobium nitride, titanium nitride, vanadium nitride, zirconium nitride, hafnium nitride, aluminum nitride, carbon nitride, metal oxides including zirconium oxide, aluminum oxide, and mixtures of thereof. Alternating layer arrangement, such as surface coating further comprises a pyrolytic carbon, amorphous carbon, glassy carbon, graphite, graphene, carbon nanotubes, hexagonal boron nitride, tungsten, molybdenum, tantalum, niobium, vanadium, zirconium, hafnium, chromium, rhenium, and mixtures of thereof.

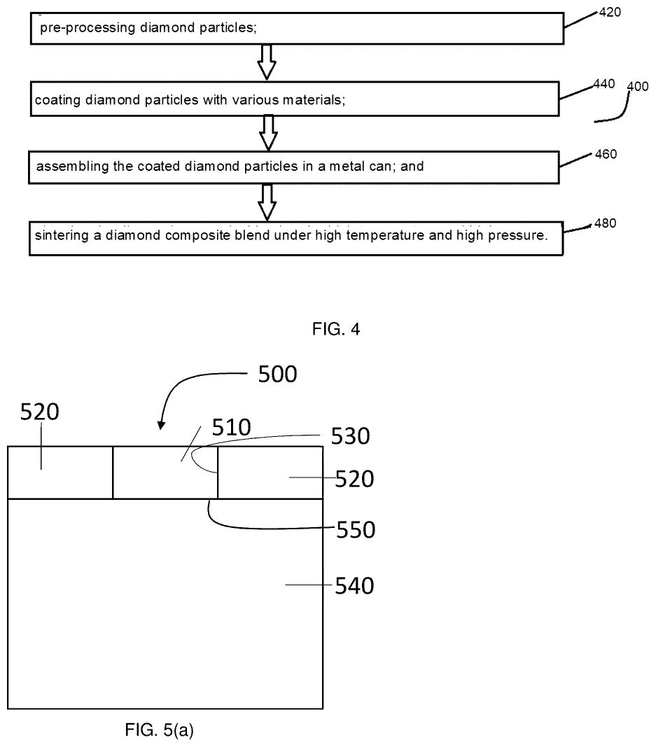

As shown in FIG. 4, a method 400 of manufacturing a superabrasive compact may comprise steps of pre-processing diamond particles at step 420; coating diamond particles with various materials at step 440; assembling the coated diamond particles in a metal can at step 460; and sintering a diamond composite blend under high temperature and high pressure at step 480.

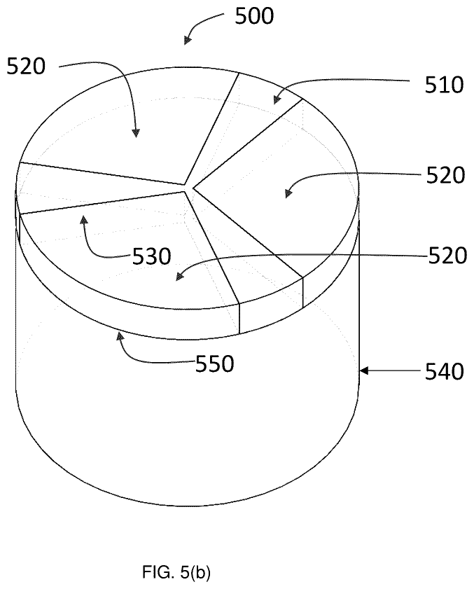

The method 400 of manufacturing superabrasive compact may further include steps of surface coating on the inorganic hard coatings of diamond particles. In one embodiment, the diamond table comprises coated diamond particles having a plurality of layers of inorganic hard coatings on surface of diamond particles (as shown in diamond table 25 of FIG. 1(a)). In another embodiment, the assembling the coated diamond particles comprises assembling a first volume of diamonds containing a coated diamond particles as a first volume (as shown in part 26 of FIG. 1(b)), and non-coated diamond particles as a second volume of diamonds (as shown in part 24 of FIG. 1(b)). In some embodiments, as shown in FIG. 5(a), the first volume of the diamonds and the second volume of the diamonds may form a concentric ring. In further another embodiment, the first volume of the diamonds and the second volume of the diamonds may form a pie slice.

The raw diamond powders are pre-processed, such as size sorting and cleaning, for example, so that they are ready to use at step 420.

Alternatively, as shown in FIG. 5(b), the first volume of the diamonds 510 and the second volume of the diamonds 520 form pizza slices with boundaries 530. The first volume of the diamonds 510 and the second volume of the diamonds 520 are bond at the boundaries 530 during an HPHT process. The boundaries 530 may be planar or non-planar/patterned. This multi-slice diamond body 500 and the substrate 540 may be bonded at the interface 550 by an HPHT process or brazing, and the interface 550 may be planar or non-planar/patterned. The shape of the polycrystalline diamond compact in the multi-slice diamond table is just for illustration purposes, and it can be any variations that separate the diamond body into multiple slices. Even though the FIG. 5(b) has shown the diamond body with 6 slices, the diamond body could be any more than 2 integer number segments, such as 2, 3, 4, 5, 6,7,8,9 . . . , for example. The first volume of diamonds 510 and second volume of diamonds 520 may have different area of sizes and may be disposed alternately on the diamond body 500.

Still in FIG. 5(b), an exemplary embodiment of assembly is configured to fabricate a polycrystalline diamond compact with a first volume of diamonds having a plurality of inorganic hard coating layers and a second volume of diamonds having no coating layers in multi-slice diamond table 500. In this assembly, the first volume of diamonds 510 having a plurality of coating layers and the second volume of diamonds 520 without coating layers are placed adjacently with a boundary 530, and disposed on a substrate 540 with a boundary 550, and together encapsulated in a metal can, and subjected to a high temperature high pressure (HTHP) process. The diamond-to-diamond bonding forms between diamond particles in both diamonds with coating layers and diamonds without coating layers. Meanwhile, the diamonds with coating layers and diamonds without coating layers are bonded together by diamond-to-diamond bonding at interface 530 like slices forming a diamond body. This multi-slice diamond body and the substrate are bonded together at interface 550. Then the assembly undergoes post-processing to obtain a PDC structure 100 illustrated in FIG. 1(a).

Additionally, it is to be understood that PCD compacts of this invention comprise a PCD body that is either entirely or partially formed from the PCD material of this invention. In the exemplary embodiment illustrated in FIG. 1(a), the PCD compact comprises a PCD body that is made up entirely of the PCD material of this invention, i.e., comprising a plurality of coated diamond particles distributed throughout. Alternatively, FIG. 1(b) illustrates a PCD compact embodiment 100 of this invention where only a portion of the PCD body 10 is formed from the PCD material of this invention. In such embodiment, the PCD body 100 comprises a first layer 26 that comprises the PCD material of this invention, and a second layer 24 positioned adjacent to the first layer that does not. The first layer 26 can be positioned adjacent to a working surface of the PCD compact to take advantage of the improved toughness. The first region can comprise any type of conventional PCD material or non-PCD-containing material.

In yet another embodiment, a pre-sintered tungsten carbide green body 20 as shown in FIG. 1(a) may be inserted into the tantalum cup instead of cemented tungsten carbide. The loaded cup is further assembled using HPHT cell components and is subjected to a cubic press for HPHT sintering process. The sintered piece is further ground and machined to the final size of the PCD product as illustrated in the FIG. 1(a).

The above-identified PCD material first embodiment will be better understood with reference to the following example:

### EXAMPLE 1

PDC cutters are produced by the methods described in the prior art, composed of a starting diamond powder having a plurality of coating layers with grain size of from about 10 nm to about 500 microns in diameter, and a cemented WC—Co (with 10-15 wt % Co) substrate, attached to the polycrystalline diamond via an interface between the polycrystalline diamond and tungsten carbide.

The tantalum cup is loaded by a volume of diamond composite which has a plurality of inorganic hard coatings, followed by inserting a WC—Co substrate (OD 0.711″). The assembled tantalum cup was further encapsulated with salt and graphite sleeves as well as some graphite pills. The tantalum cup fits inside the sleeves tightly. The encapsulated assembly is transferred into cell loading area, and the entire body is loaded into the cell specifically designed for cubic press. The cell is then loaded into the space formed by the cubic press anvils and is applied a high pressure and high temperature (HPHT) cycle to the cell for 30 minutes. The soak pressure is maintained around 6.0 GPa and the soak temperature was about 1550° C. The soak time for bonding of the diamond disc to the carbide was about 10 minutes. After the bonding cycle, the cup is taken out of the pressed cell for further post processing.

The cutter is ground and finished to 16 mm in diameter, and 13.2 mm in height. A 45 degree bevel is placed on the edge of the diamond, with a thickness of about 0.4 mm.

While reference has been made to specific embodiments, it is apparent that other embodiments and variations can be devised by others skilled in the art without departing from their spirit and scope. The appended claims are intended to be construed to include all such embodiments and equivalent variations.

We claim:

1. A superabrasive compact, comprising:
a diamond body, wherein the diamond body comprises:
diamond particles having a plurality of layers of inorganic hard coatings on surface of diamond particles, wherein the plurality of layers of inorganic hard coatings have thickness ranging from about 0.1% to about 20% of the size of the diamond particle; and
a metallic substrate in direct contact with the diamond body.

2. The superabrasive compact of claim 1, wherein the inorganic hard coatings are at least one of coatings of diamond, diamond-like carbon (DLC), lonsdaleite, metal carbides including boron carbide, tungsten carbide, silicon carbide, tantalum carbide, niobium carbide, molybdenum carbide, titanium carbide, vanadium carbide, zirconium carbide, hafnium carbide, metal nitrides including cubic boron nitride (CBN), silicon nitride, tantalum nitride, niobium nitride, titanium nitride, vanadium nitride, zirconium nitride, hafnium nitride, aluminum nitride, carbon nitride, metal oxides including zirconium oxide, aluminum oxide, and mixtures of thereof.

3. The superabrasive compact of claim 1, wherein the inorganic hard coatings have surface coatings on each one of the inorganic hard coatings.

4. The superabrasive compact of claim 1, wherein the metallic substrate comprises a metal carbide.

5. The superabrasive compact of claim 1, wherein materials for the inorganic hard coatings have Knoop hardness value of greater than or equal to about 1,300 Kgf/mm².

6. The superabrasive compact of claim 1, wherein the diamond body has a first volume of the diamonds and a second volume of the diamonds.

7. The superabrasive compact of claim 6, wherein the first volume of the diamonds and the second volume of the diamonds form multilayers with boundaries.

8. The superabrasive compact of claim 6, wherein the first volume of the diamonds particles have the plurality of layers of inorganic hard coatings on surface of diamond particles, wherein a second volume of the diamonds particles have no layers of inorganic hard coatings.

9. The superabrasive compact of claim 6, wherein the first volume of the diamonds and the second volume of the diamonds form slices with boundaries.

10. The superabrasive compact of claim 3, wherein the surface coating is at least one of coatings of pyrolytic carbon, amorphous carbon, glassy carbon, graphite, graphene, carbon nanotubes, hexagonal boron nitride, tungsten, molybdenum, tantalum, niobium, vanadium, zirconium, hafnium, chromium, rhenium, and mixtures of thereof.

11. A superabrasive compact, comprising:
a diamond body comprising:
a first volume of diamond particles having a plurality of layers of inorganic hard coatings on surface of diamond particles, wherein the plurality of layers of coatings have thickness ranging from about 0.1% to about 20% of the size of the diamond particle, wherein the plurality of layers of coatings are at least one of coatings of diamond, diamond-like carbon (DLC), lonsdaleite, metal carbides including boron carbide, tungsten carbide, silicon carbide, tantalum carbide, niobium carbide, molybdenum carbide, titanium carbide, vanadium carbide, zirconium carbide, hafnium carbide, metal nitrides including cubic boron nitride (CBN), silicon nitride, tantalum nitride, niobium nitride, titanium nitride, vanadium nitride, zirconium nitride, hafnium nitride, aluminum nitride, carbon nitride, metal oxides including zirconium oxide, aluminum oxide, and mixtures of thereof.

12. The superabrasive compact of claim 11, wherein the diamond body further comprises a second volume of diamond having no layers of inorganic hard coatings.

13. The superabrasive compact of claim 11, wherein the inorganic hard coatings have surface coatings on each one of the inorganic hard coatings.

14. The superabrasive compact of claim 11, wherein the inorganic hard coatings have Knoop hardness value of greater than or equal to about 1,300 Kgf/mm².

15. The superabrasive compact of claim 12, wherein the first volume of the diamonds and the second volume of the diamonds form a multilayer structure.

16. The superabrasive compact of claim 12, wherein the inorganic hard coatings have surface coatings on each one of the inorganic hard coatings.

17. The superabrasive compact of claim 12, wherein the first volume of the diamonds and the second volume of the diamonds form slices with boundaries.

18. A method of manufacturing a superabrasive compact, comprising:
pre-processing diamond particles;
coating diamond particles with various materials;
assembling the coated diamond particles in a metal can; and
sintering a diamond composite blend under high temperature and high pressure.

19. The method of manufacturing superabrasive compact of claim 18 further comprising surface coating on the coated diamond particles.

20. The method of manufacturing superabrasive compact of claim 18, wherein the assembling the coated diamond particles comprises assembling a first volume of diamonds containing a coated diamond particles as a first volume and non-coated diamond particles as a second volume of diamonds.
